(19) United States
(12) Patent Application Publication
(10) Pub. No.: US 2008/0083476 A1
(43) Pub. Date: Apr. 10, 2008

(54) WOOD INDEXING RACK

(76) Inventor: BRET JONES, MERIDIAN, ID (US)

Correspondence Address: DYKAS, SHAVER & NIPPER, LLP, P.O. BOX 877, BOISE, ID, 83701-0877, US

(21) Appl. No.: 11/539,501

(22) Filed: Oct. 6, 2006

(51) Int. Cl. B27C 9/00

(52) U.S. Cl. 144/2.1

(57) ABSTRACT

A wood indexing or sorting device for use with an automated cutoff saw. The indexing rack has a number of chambers for sorting pieces of wood for later assembly into cabinet and door components. A swing out assembly of chamber walls is rotatable into position between fixed chamber walls, to divide the sorting chambers into more slots of smaller width. Pieces of wood from the cutoff saw are sorted in sorting chambers, with each sorting chamber corresponding to a part number of a work order.

### CROSS-REFERENCE TO RELATED APPLICATIONS

### FIELD OF THE INVENTION

The present invention generally relates to sorting devices associated with saws, and more particularly to sorting systems for automated push cut saws.

### BACKGROUND OF THE INVENTION

Wooden doors for cabinets are made out of smaller pieces of wood that are glued together. A typical construction for a cabinet door might include 3 or 4 pieces of wood for the center panel, with each piece being for instance, 1 inch thick and 3 inches wide. These would be glued and clamped edge-to-edge to form a center panel, and that center panel would be trimmed to the chosen size and shape of the center panel for the door. The center panel would be surrounded on four sides by pieces of wood which would form the frame of the door and which would secure and enclose the panel. Thus, a single panel cabinet door might be made of seven or eight pieces of wood of different sizes. A cabinet builder might place an order for a complete set of kitchen cabinet doors for a certain project, in which he might specify 20 or more doors of a certain style, with some of those doors being different sizes. Thus, a single order for one cabinet project might require cutting 100 or more pieces of wood of different sizes, and fitting them together to form 20 or 30 cabinet doors of different sizes.

The pieces of wood are cut to size with a push cut saw. Traditionally, these have been manual push cut saws, which an operator uses to cut wood to various lengths. A new type of saw which is available to makers of cabinet doors is an automated push cut saw. With an automated push cut saw, a worker marks the piece of wood with a marking pen, to indicate sections of wood which contain defects such as cracks or knot holes which should be cut out. A device in the automated push cut saw scans the piece of lumber and takes note of the sections which are to be cut out as flawed sections. The automated push cut saw also has a list of doors that are to be made, stored in its memory. Also stored in its memory is a parts list of all of the door pieces which will be required to create the doors that are in the order list. After scanning the length of wood and taking note of where cuts have to be made to eliminate knot holes or the defects, the automated push cut saw then calculates the most efficient way to cut up a piece of wood in order to fulfill the requirements of the wood pieces that are needed to fulfill one or more orders.

After the pieces are cut by the automated push cut saw they are moved by a belt and dropped onto a working table from which workers typically carry them in a bin or wheelbarrow to another part of the operation where they are sorted into different sizes. Each of the pieces of wood is imprinted with a coded number as it goes through the push cut saw. The coded number indicates which project it is for and which piece of which door that piece of wood is for. The number is placed on the wood for identification purposes later in the process.

### SUMMARY OF THE INVENTION

The invention is an indexing or sorting device which allows workers making a run of cabinet doors to sort the wood pieces that have been cut by an automated push cut saw. The indexing sorter can be used by almost any one using a push cut saw. As the pieces exit the saw and are ejected onto a sorting table, which is part of the invention, workers can look at the coded number and determine which part number each piece of wood is for. Above the sorting table is a series of chambers which have walls separating one chamber from another and which have an open front. Each chamber is labeled to identify which piece of wood should go into it. The workers sort the wood pieces on the sorting table, by placing them into the chambers on a rack above the sorting table. The chambers of the sorting table would typically be 6 inches wide and the indexing rack and the sorting table could be about 30 feet long. The indexing rack and the sorting table are built together in one frame.

The output of the push cut saw is so sufficient that more than one indexing system could be arranged in order to handle the output of one automated push cut saw. Thus, when a sufficient quantity of wood has been delivered to one sorting table, the output of the automated push cut saw could then be routed to the next indexing and sorting table. While the workers at the first indexing and sorting table are sorting though the wood on that table, the next indexing and sorting table along the line would be filling up with pieces of wood. A third or even more indexing and sorting tables would also be possible. Without sufficient indexing and sorting tables, the automated push cut saw has to be run intermittently so that its output of wood can be sorted before more wood is cut. Thus, to fully utilize the capacity of an automated push cut saw, a number of indexing and sorting racks and tables are needed. Having them directly on the output line of the push cut saw also allows efficient processing of the wood, since they do not have to be carried to another place for sorting.

If the sorting chambers are about 6 inches wide, a handy size for the sorting rack is about 12 to 15 feet, although indexing racks could be made to any desired length. An indexing rack 12 feet long would provide 24 sorting chambers, if the chambers were 6 inches wide. 6 inches wide is convenient for many types of doors.

An additional feature of the invention is that additional chambers can be added by rotating a separate rack containing mid-spaced chamber walls into position in the first rack of indexing chambers. The rack of additional chamber walls is attached to a rod which is able to rotate. On the rod are attached a number of chamber walls which can rotate into place forming smaller chambers when they are placed between the first row of chamber walls. When rotated into place to form additional and smaller chambers, the additional chambers would be 3 inches wide instead of the original 6 inches wide. This would provide the option of having more sorting chambers into which to sort wood pieces, and smaller chambers which might be more appropriate for certain jobs. The second group of sorting chamber walls is rotated in and out of place by rotating the rod to which they are attached until the chambers are out of the way of the original chambers. The rod can be rotated 90 degrees for instance, or 180 degrees if that is necessary. A full set of secondary chamber walls can be utilized, or they can be in banks of one or more secondary walls. For instance, a bank ¼ the length of the first bank of indexing chambers could be swung into place, or banks dividing ½, or ¾ of the first bank, or individually secondary chambers walls can be used.

The second group of indexing chamber walls can be rotated in various ways. One way to rotate the rod to which the secondary chamber walls are attached, is to attach a lever to the rod to which the secondary chamber walls are attached, is to attach a lever to the rod to one or both ends of the rod, and simply lift the rod with a full length bank of secondary chamber walls up and out of the way be mechanical force. Other methods of rotating the rod are also possible, including by hydraulics, by gears which are driven by various power sources, or by other conventional methods of rotating the rod.

One option for sorting of the wooden pieces is to combine the indexing rack described above with an automated manipulation or sorting system. Since each of the pieces of wood are coded after being sawn to identify which project they are for, which door they are for, and which piece of the door they are made for. A second scanner can be utilized to read the code on each piece of wood, pick up the piece of wood, and place it in the appropriate sorting chamber. Alternatively a sorting system can be utilized in which diverter gates open and close to divert a piece of wood from the output belt and into an indexing chamber. The selection would be made based on the code imprinted on the piece of wood, and the selected indexing chamber would correspond to the type of piece of wood indicated in the code. An incrementing stacker would be an option, so that the piece of wood does not fall into a pile, but it is placed on a stack which drops the thickness of one piece of wood as each new piece of wood is added.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the indexing rack of the invention.

FIG. 2 is a side view of a robotic arm for use with the indexing rack.

FIG. 3 is a perspective view of the indexing rack of the invention with the secondary indexing set in a raised position.

FIG. 4 is a plan view of the indexing rack of the invention with an automatic sorter.

### DESCRIPTION OF THE PREFERRED EMBODIMENTS

In the following description and in the figures, like elements are identified with like reference numerals. The use of “or” indicates a non-exclusive alternative without limitation unless otherwise noted. The use of “including” means “including, but not limited to,” unless otherwise noted.

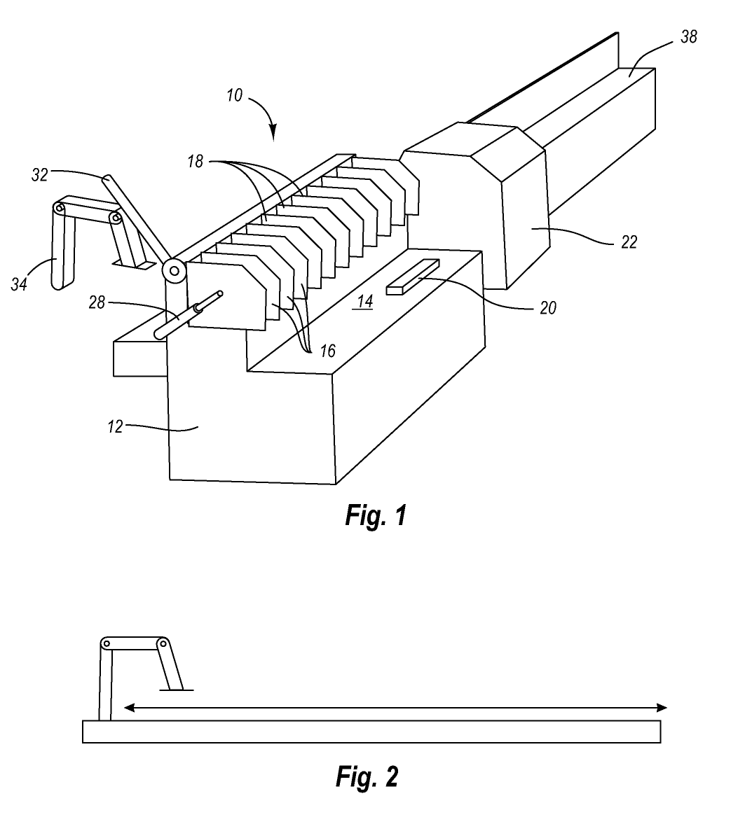

The FIGS. 1-4 show the preferred embodiment of the invention. FIG. 1 shows the indexing rack 10 of the invention, which is located adjacent to an automated push cut saw 22. The automated push cut saw 22 includes a feed table 38 on which long pieces of wood are placed before they enter the saw 22. One specific type of cutoff saw this device could be used for is a OptiCut 100 or Grecon Dimter push cut saw, but any saw of this type may be benefited by the use of the indexing rack. Attached to the indexing rack 10 is a sorting table 14, which is located adjacent to the output of the wood of the automated push cut saw 22. As material from the saw is processed and cut into smaller pieces of wood, the wood pieces 20 are deposited onto the sorting table 14.

An identification number is placed on each wood piece 20, which identifies the particular part which that piece is going to be utilized for. Each part of a production run will be associated with an indexing chamber 16. In order to sort the wood pieces, a wood piece is placed according to its number in the corresponding indexing chamber. For instance one indexing chamber may be for center panels of a certain size of door. The next indexing chamber may be for the left side walls of that size of door. Thus, one particular door to be made might have 5 indexing chambers associated with it and any production run might be for a number of different sizes of doors.

An inventory parts list is maintained in the automated push cut saw to know what pieces are required to complete the one or more orders, and to know what pieces have already been cut to fulfill that order. As wood is cut, the computing means of the push cut saw calculate what pieces need to be filled for the order, and what pieces have already been cut for the order. When all of the pieces for the order are cut, the automated push cut saw will cease cutting wood. The push cut saw can store the information for more than one order in its memory, and will cut wood until all of the pieces for that order are complete.

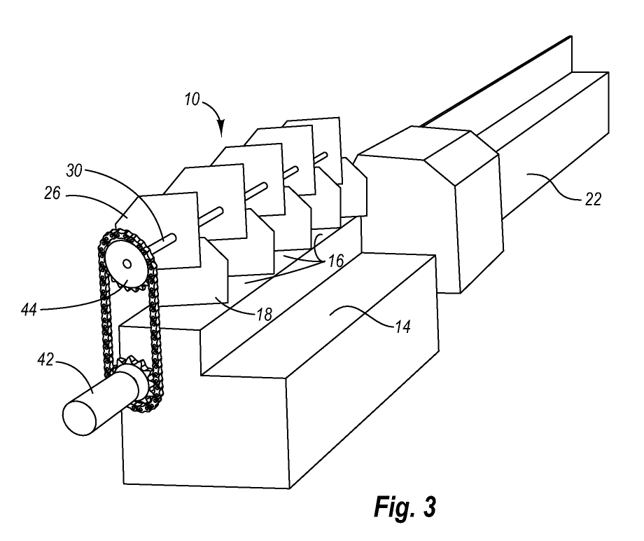

The sorting table is a generally rectangular table with a smooth surface in which the wood pieces can be accumulated as they are cut and from which they can be moved into the indexing chamber 16 as they are sorted. The sorting chambers are formed by a number of chamber walls 18. For some projects it will advantageous to have indexing chamber 16 be a certain width. For other projects a larger or smaller width may be more desirable. To provide the indexing rack 10 with more indexing chambers 16 of which each are smaller width, a secondary indexing set 26 is utilized, this is shown in FIG. 3. The secondary indexing set is a group of chamber walls 18 which are mounted on a rotating rod 30. The rotating rod 30 has a hinge point 40. The secondary indexing set can be rotated into position between the existing chamber walls 18, as shown in FIG. 2. They can also be rotated out of position, as shown in FIG. 3, to provide fewer indexing chambers of a greater width. FIG. 1 shows the secondary indexing set 26 with the capability of being rotated with a hydraulic ram 38 or a lever 32. FIG. 3 shows the indexing rack 10 of the invention with the secondary indexing set rotated out of position to create fewer indexing chamber 16 of a larger width. The secondary indexing set may be as long as the indexing rack, or maybe divided into a number of secondary indexing sets such that two three or more sets of secondary indexing sets with their chamber walls can be moved in or out of position as needed. FIG. 3 shows the secondary indexing set 26 moved into the open position by the use of a motor 42 and gears 44. The motor 42 can be an electric motor. The indexing rack 10 and sorting table 14 can be of any size, depending on the sized needed for a particular application, and on the number of pieces need to be sorted and segregated. In one application, it is advantageous for the indexing rack to be about 15 feet long, with indexing chambers 6 inches wide when the secondary set of chamber walls are moved into place. This unit would have 30 indexing chambers, or 15 when the secondary set of chamber walls are rotated out of position. For some projects of operations, a sorting table 30 feet long or longer would be advantageous. A metal table top is advantageous, such as steel or aluminum. The sorting chamber walls are advantageously made of steel ⅛ in thick, and are plates approximately 18″ by 15″.

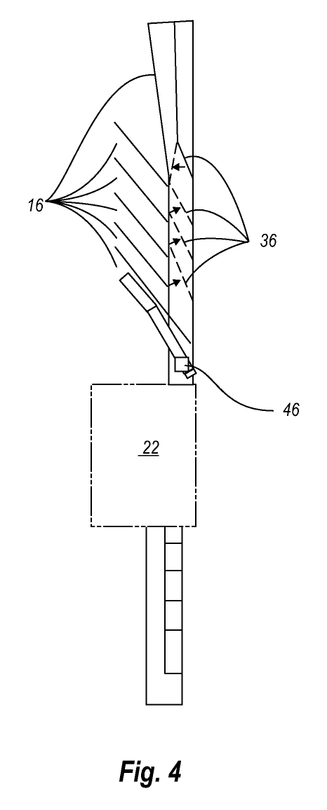

FIG. 4 shows a version of the indexing rack 10 as seen from above. This version includes an outlet belt 24 from the automated push cut saw 22. Located along the outlet belt are indexing chambers 16. The indexing chamber 16 is formed by chamber walls 18. A portion of the chamber wall 18 extends out over the output belt 24 in the form of diverter gates 36. The diverter gates 36 are normally in a position which does not obstruct the output belt 24. A code reader 46 is located after the push cut saw 22 and before the indexing chamber 16. The code reader 46 reads the product code that is imprinted in each wood piece 20. When an identification code off of a wood piece 20 is read, the diverter gate 36 for the appropriate indexing chamber 16 opens, and the wood piece is fed into that indexing chamber. After the wood piece enters the indexing chamber, the diverter gate closes to allow passage of other pieces of wood. This particular configuration of sort includes indexing chambers at the end of the belt, which are close to being parallel with the belt so that longer pieces of wood may be routed to them so that the longer pieces of wood won't jam in the indexing chambers that diverts to the side. Obviously the indexing chambers could be designed to be built on both sides of the output belt. The indexing chamber can be bin like devices in which pieces of wood drop into a storage container, which has the capacity to hold a number of pieces of wood. The floor of the indexing chamber can also be spring loaded, to lower as each piece of wood is entered into it, so that each piece of wood doesn't drop onto other pieces of wood, but that the whole stack is gradually lowered as it fills. A feed table 38 is shown for the automated push cut saw 20 and a piece of wood 48 with dotted lines indicating where it may be cut into smaller pieces by the automated push cut saw 22.

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

I claim:

1. A wood indexing rack for indexing wood pieces from an automated cutoff saw with an output belt, in which the automated cutoff saw produces and places an identification marking on wood pieces of various sizes for assembling into doors made of wood pieces, comprising:
a sorting table adjacent to the output belt of the cutoff saw, configured for receiving wood pieces from the output belt of the cutoff saw;
a plurality of indexing chambers adjacent to the sorting table, with each indexing chamber formed between two chamber walls and designated for wood pieces of selected dimensions corresponding to a particular piece of a door and corresponding to said identification marking designating said particular piece;
wherein the wood pieces from the automated cutoff saw are delivered to the sorting table of the device, from which each wood piece is placed in the indexing chamber corresponding to said identification marking placed on each wood piece by said cutoff saw.

2. The wood indexing device of claim 1 further in which said sorting table is connected to said indexing chamber.

3. The wood indexing device of claim 1 further comprising the indexing rack is above the sorting table

4. The wood indexing device of claim 1 in which the sorting table is configured to receive wood pieces from the output belt of the cutoff saw, with output belt delivering wood pieces to the back of the sorting table.

5. The wood indexing device of claim 1 which further includes one or more secondary chamber walls which are rotatable from a position outside said indexing chambers to a position inside said indexing chambers, with the secondary chamber walls dividing the indexing chambers into smaller and more numerous indexing chambers.

6. The wood indexing device of claim 6 in which said one or more secondary chamber walls are grouped into one or more sets of secondary chamber walls, with each set of secondary chambers walls linked together for rotation of the set of secondary chamber walls as a unit to a position inside said indexing chambers, with the secondary chamber walls dividing the indexing chambers into smaller and more numerous indexing chambers.

7. The wood indexing device of claim 6 in which said or more sets of secondary chamber walls are rotated by a lever attached to said set of secondary chambers walls.

8. The wood indexing device of claim 6 in which said or more sets of secondary chamber walls are rotated by a hydraulic piston attached to said set of secondary chambers walls.

9. The wood indexing device of claim 6 in which said or more sets of secondary chamber walls are rotated by gears and a power source.

10. The wood indexing device of claim 1 in which the wood pieces are sorted by automated sorter into said indexing chambers, by use of said identification marking imprinted on said wood piece by said cutoff saw.

11. The wood indexing device of claim 10 in which the automated sorter is a mechanical arm that lifts wood pieces and places them in an indexing chamber corresponding to said identification marking on each of said wood pieces.

12. The wood indexing device of claim 10 in which said automated sorter is a plurality of diverter gates adjacent to said output belt which open to divert a particular wood piece from the output belt into an indexing chamber corresponding to the identification marking on the wood piece.

13. A wood indexing rack for indexing wood pieces from an automated cutoff saw with an output belt, in which the automated cutoff saw produces and places an identification marking on wood pieces of various sizes for assembling into doors made of wood pieces, comprising:
a sorting table adjacent to the output belt of the cutoff saw, configured for receiving wood pieces from the output belt of the cutoff saw;
a plurality of indexing chambers adjacent to the sorting table, with each indexing chamber formed between two chamber walls and designated for wood pieces of selected dimensions corresponding to a particular piece of a door and corresponding to said identification marking designating said particular piece;
one or more sets of secondary chamber walls, with each set of secondary chambers walls linked together for rotation of the set of secondary chamber walls as a unit to a position inside said indexing chambers, with the secondary chamber walls dividing the indexing chambers into smaller and more numerous indexing chambers;
wherein the wood pieces from the automated cutoff saw are delivered to the sorting table of the device, from which each wood pieces is placed in the indexing chamber corresponding to its size, and in which the secondary walls can be moved into or out of the indexing chambers.

14. The wood indexing device of claim 13 in which said or more sets of secondary chamber walls are rotated by a lever attached to said set of secondary chambers walls.

15. The wood indexing device of claim 13 in which said or more sets of secondary chamber walls are rotated by a hydraulic piston attached to said set of secondary chambers walls.

16. The wood indexing device of claim 13 in which said or more sets of secondary chamber walls are rotated by gears and a power source.

17. The wood indexing device of claim 13 in which the wood pieces are sorted by automated sorter into said indexing chambers, by use of said identification marking imprinted on said wood piece by said cutoff saw.

18. The wood indexing device of claim 17 in which the automated sorter is a mechanical arm that lifts wood pieces and places them in an indexing chamber corresponding to said identification marking on each of said wood pieces.

19. The wood indexing device of claim 17 in which said automated sorter is a plurality of diverter gates adjacent to said output belt which open to divert a particular wood piece from the output belt into an indexing chamber corresponding to the identification marking on the wood piece.
